(19) United States
(12) Patent Application Publication
(10) Pub. No.: US 2009/0310364 A1
(43) Pub. Date: Dec. 17, 2009

(54) ATTACHABLE ILLUMINATION ACCESSORY FOR WALKER

(76) Inventor: Cornelius Turner, Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/139,721

(22) Filed: Jun. 16, 2008

(51) Int. Cl. F21V 33/00; A61H 3/00

(52) U.S. Cl. 362/253; 135/67

(57) ABSTRACT

An illumination accessory for a walker is disclosed which includes at least one non-flammable light supporting structure, at least one attachment member adapted to attach at least one light supporting structure to at least one structural component of the walker and at least one shatter-resistant, light emitting component which will not cause burns on skin.

### FIELD OF INVENTION

This invention relates generally to the field of illuminated walking aids, and in particular to an attachable illumination accessory for a walker.

### BACKGROUND

Walkers to stabilize elderly, weak, or disabled persons and assist them in walking or preventing falls are well known in the art.

While walkers provide stability, negotiating with a walker in the dark or even in low or reduced light situations may present obstacles. For example, it may be difficult for an elderly or disabled person to locate a walker at night in a darkened room (e.g., upon awakening to use the bathroom). It may also be difficult at night or in low-light settings for an elderly person see a step or object in front of the walker, presenting a greater danger of tripping of falling.

Illuminated walkers are well known in the prior art. For example, U.S. Patent relevant prior art references are U.S. patent application Ser. No. 11/708,827 (Gallo '827) and U.S. Pat. No. '6,463,947 (Wipperfurth '947). Gallo '827 teaches a walker with illumination wired through one or more of the hollow metal, tubular legs of an otherwise conventional walker. Wipperfurth '947 teaches a lighted walker with the light source in the upright portions of the walker and canes. The illumination is then directed in the forward direction through the use of rounded reflectors within the uprights.

However, there are numerous production and marketing obstacles to illuminated walkers which prevent them from being available and accessible to the elderly and disabled.

One such obstacle is that it may not be economically feasible for an elderly or disabled person to purchase a new walker, particular if medical assistance or insurance reimbursement would be required to fund the purchase. Additionally, elderly and disabled users are resistant to purchasing a “new” walker when the walker they have is still functional. This resistance is a further marketing obstacle.

A further obstacle to the marketing and widespread use of walkers which are sold in retail settings is that they require considerable “shelf space” and thus the decision to carry an additional, more costly walker for limited clientele requiring them is a marketing obstacle. The vast majority of retail stores (including medical supply stores) which carry walkers stock only one or a few brands and selections. Further, walkers are relatively large, therefore if they are sold by mail order and/or shipped for retail they are costly objects to ship.

Additionally, illuminated walkers are difficult to manufacture and sell because they require considerable labor to install wiring components.

While various devices, such as lights mounted on clamps, may be attached to walkers, these devices are generally not securely mounted, and the lights pose a safety issue because an elderly or disabled person may inadvertently touch a heated lighting surface.

It is therefore desirable to create an inexpensive accessory which can be safely used to illuminate existing walkers, and which can be economically stored, sold and shipped.

### GLOSSARY

As used herein, the term “walker” shall refer to a device used to provide support in walking and ambulation, and may include a conventional walker, a cane, a motorized walker, a medical support device, a cart, a wheeled device, or a wheel chair. A walker may be used by elderly, weak, injured or disabled persons. A walker may be made from any metal (e.g., steel or aluminum), plastic, or other compound known in the art. Walkers may be of standard, commercially available widths and sizes, or may be of specialized or even customized dimensions. A walker may be singly molded or constructed of multiple components.

As used herein, the term “attachable” means capable of being selectively attached and/or detached. An attachable device may be temporarily or permanently affixed.

As used herein, the term “illumination accessory” means a component which illuminates or provides lighting, such as a phosphorescent material, powered lighting, battery operated illumination, or any other lighting means.

As used herein, the term “attachment member” means a mechanism to tie, strap, snap, band, affix, bolt, screw, or fasten one thing to another. Examples of attachment members may include Velcro, snaps, bolts, screws, ties, magnets, fitted interlocking components, adhesives, special configured apertures and protuberances, hooks, clamps, and bolts.

As used herein, the term “light supporting structure” means a component of an illumination accessory to which any light emitting component may be incorporated within or attached, or which supports other components or structural elements to which light emitting components may be incorporated. The light supporting structure itself may serve as a light emitting component.

As used herein, the term “power supply” means a source of energy including but not limited to electrical power, batteries, and solar power.

As used herein, the term “light emitting components” means a device or component capable of emitting visible electromagnetic radiation.

As used herein, the term “phosphorescent” means having the capability of glowing or being visible in the dark. For example, phosphorescent means any component or material in which absorbed radiation is slowly re-emitted at a lower intensity for an extended period of time.

As defined herein, the term “shatter resistant” means having components or structural qualities which decrease the likelihood of breakage. For example, a component may be rendered shatter resistant by using shatter resistant materials, by flush mounting a component or by adding a protective structure.

### SUMMARY OF THE INVENTION

It is an object of this invention to provide a securely attachable, safe illumination accessory for selective attachment to an existing conventional walker.

It is further an object of this invention to provide an attachable illumination accessory that provides for easy attachment and detachment to transfer the device from one walker to another.

It is yet another object of this invention to provide an inexpensively manufactured, attachable illumination accessory adapted for easy storage and transport.

In accordance with the objects of this invention, an illumination accessory for a walker is disclosed which includes at a least one non-flammable light supporting structure, at least one attachment member adapted to attach the at least one light supporting structure to at least one structural component of the walker and at least one shatter-resistant, light emitting component which will not cause burns on skin.

### BRIEF DESCRIPTION OF DRAWINGS

FIG. 1a is a perspective view of a walker fitted with an attachable illumination accessory.

FIG. 1b is one embodiment of a portion of a light supporting structure which is a semi-circular tubular shaped member and which fits on a tubular member of a walker.

FIG. 2a is a side view of the attachable illumination accessory shown in FIG. 1a.

FIG. 2b is a perspective view of the attachable illumination accessory shown in FIG. 1a.

### DETAILED DESCRIPTION OF EMBODIMENTS OF THE INVENTION

For the purpose of promoting an understanding of the present invention, references are made in the text hereof to embodiments of an attachable illumination accessory for a walker, only some of which are described herein. It should nevertheless be understood that no limitations on the scope of the invention are thereby intended. One of ordinary skill in the art will readily appreciate that modifications such as the means of attachment and the number and location of lights are possible. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related.

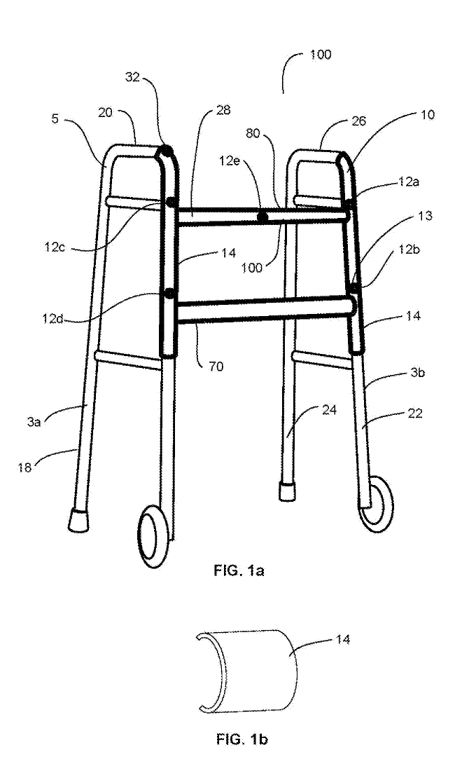

Referring now to the drawings, FIG. 1a shows one embodiment of a walker 5 and illumination accessory 10 forming a lighted walking system 100. In the embodiment shown, illumination accessory 10 is configured as an attachable sheath having light emitting components 12a, 12b, 12c, 12d and 12e. In the embodiment shown, light emitting components 12a-e are flush mounted to prevent breakage, burning of skin, or entanglement. In some embodiments, lighting components 12a-e may have an optional protective covering 13 for safety.

Other embodiments may have fewer or more light emitting components 12a-e. In the embodiment shown, illumination accessory 10 is formed of 0.125 Black Haircell ABC, for example such as commercially available through W/H Plastics, Inc. (Milwaukee, Wis.).

In the embodiment shown, walker 5 is conventional walker comprising a first inverted U-shaped tubular support member 3a defining first 16 and second 18 legs joined by a first handle 20 and a second inverted U-shaped tubular support member 3b defining third 22 and fourth 24 leg members joined by a second handle 26. At least one walker support member 28 joins the first and third leg members 16 and 22 to connect the first and second inverted U-shaped tubular support members 3a and 3b. The number, configuration, and placement of support members 28 may vary.

Other embodiments of this invention may be adapted for simplified or more complex support structures. Illumination accessory 10 can adapted to fit as a sheath-like component or may otherwise be attached. In other embodiments, support members (e.g. support members 3a and 3b) may not be U-shaped.

In the embodiment shown, illumination accessory 10 comprises two vertical convex light supporting structures 14 joined together by at least one convex light supporting structure 70. Other embodiments may include more or fewer light supporting structures 14, or differently configured light supporting structures 14, such as strips, magnetic components, panels, or reflectors.

In the embodiment shown, two essentially vertical and parallel first and second light supporting structures 14 are attached to two essentially horizontal light supporting structures 70 and 80. In the embodiment shown, light support structures 14, 70, and 80 are made from a singly molded plastic. Other embodiments may be machined, extruded or tooled from metal, or may be constructed from multiple molded, extruded, machined components or from a combination of components made of various materials. Various components may be attached or affixed to walker 5 in varying manners. Other embodiments may include fewer or more light supporting structures 14, 70, and 80 and such structures 14, 70, and 80 may be configured in a manner other than vertically or horizontally, so long as such light supporting structures 14, 70 and 80 are configured in a manner suitable for mounting or attachment to a walker 5.

FIG. 1b shows a partial side perspective view of light supporting structure 14 as shown in FIG. 1a. In the embodiment shown in FIG. 1b, light supporting structures 14 and 80 are shaped in a manner complementary to the U-shaped tubular support members 3a and 3b and are fitted to tubular support members 3a and 3b. Supporting structure 70 is hollow and contains batteries or other power source for light emitting components 12a-e. In various embodiments, supporting structures 70 and 80 may be positioned differently, or in some embodiments may be functionally combined.

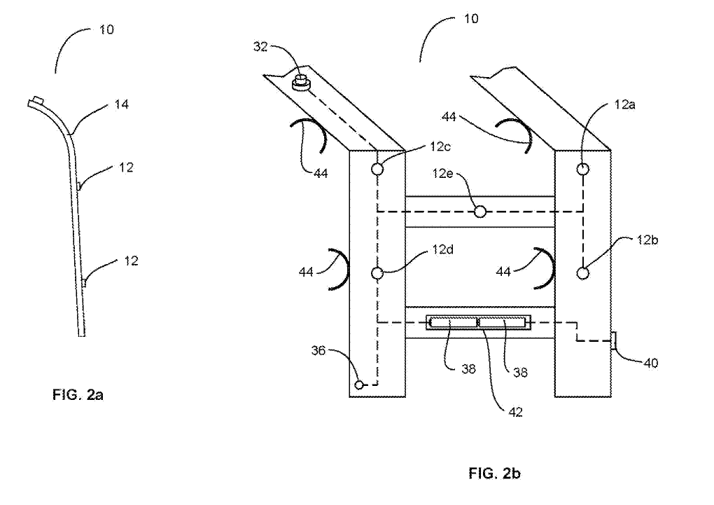

FIG. 2a is a side view of the illumination accessory 10 shown in FIGS. 1a and 1b. FIG. 2a further illustrates how illumination accessory 10 is adapted to emit light and may be selectively attached to the walker 5 (not shown) in reduced light or darkened settings. In other embodiments, illumination accessory 10 may be permanently affixed to a walker 5, or manufactured as a component of a walker 5.

FIG. 2b further illustrates how light supporting structures 14 are adapted to be placed over and selectively attached to the first and third legs 16 and 22 of walker 5 and may extend over at least part of the first and second handles 20 and 26. The horizontal light supporting structure 80 is adapted to be placed over and selectively attached to the horizontal support bar 28 of the walker 5 with attachment members 44.

In the embodiment shown, attachment members 44 are plastic clamps which snap or securely attach to u-shaped tubular support members 3a and 3b. In other embodiments, attachment members 44 may be Velcro straps, ties, straps with buckles or snaps, elasticized material, bolts, fitted edges, or permanent affixation such as adhesive or welding.

The number, configuration, and placement of light supporting structures 14, 70, and 80 may be varied so as to complement the number, configuration, and placement of walker support members 28 and/or u-shaped tubular support members 3a and 3b.

It is contemplated that illumination may be provided by any one or a combination of any of a variety of light sources including electrically or battery powered lighting, solar lighting, or phosphorescent material. For example, in one embodiment, illumination accessory 10 is entirely formed of a phosphorescent or “glow in the dark” material in which absorbed radiation is slowly re-emitted at a lower intensity for an extended period of time. In other embodiments, horizontal light supporting structures 70 and 80 and vertical light supporting structures 14 are selectively made from phosphorescent materials.

FIG. 2b illustrates an embodiment of illuminating accessory 10 in which a power source 38 is rechargeable using a conventional adaptor or jack 36 known in the art and which plugs into a household electrical outlet (not shown). In the embodiment shown, power source 38 consists of four AA rechargeable batteries places in a battery holder, as is known in the art. In other embodiments, power source 38 may be a solar panel, phosphorescent components, more or fewer batteries, or non-rechargeable batteries.

Alternatively, rechargeable batteries and replacement phosphorescent units may be used. In the illustrated embodiment, wiring W (shown in phantom lines) provides electrical communication between an On/Off switch 32, light emitting components 12a-e, charge outlet (not shown), power source (e.g., batteries) 38, and an optional alarm button 40.

In the embodiment shown in FIG. 2b, the illumination accessory 10 includes at least one light emitting component 12a-e selectively controlled by the On/Off switch 32. Desirably, the On/Off switch 32 is positioned for easy finger control by the user. In the illustrated example, the switch 32 is positioned near the top of a vertical light supporting structure 14 at the first handle 20 to readily accommodate a right-handed user. Alternatively, the On/Off switch 32 may be positioned near the top of the vertical light supporting structure 14 at second handle 26 area to readily accommodate a left-handed user (not shown).

The On/Off switch 32 allows for selective control by the user of light illumination from the accessory 10 by controlling light emitting components 12a-e spaced at uniform or varying intervals along the accessory 10. In adequate lighting situations when no additional illumination is desired, the switch 32 is left in the “off” position. In situations with reduced or no light, the user manipulates the switch 32 from the “off” position to the “on” position, thereby turning on the light emitting components 12a-e to provide additional illumination.

It is to be understood that the number, type, and placement of light emitting components 12a-e may be varied to provide the desired amount of illumination. For example, light emitting components 12a-e may take the form of incandescent or fluorescent light bulbs (e.g., intermittently flashing light) or a light-emitting diode (LED).

In the embodiment shown, light emitting components 12a-e are powered by power source 38. In the illustrated embodiment, the power source 38 consists of battery or series of batteries contained within a housing 42. In one embodiment, the batteries are rechargeable to facilitate long-term use. In this embodiment, the accessory 10 includes a plug-in charge outlet (not shown) for recharging the power source 38.

It is contemplated that other power sources 38 may adapted to control the light emitting components 12a-e. For example, the light emitting components 12a-e may be powered by a solar cell or other non-electrical power source.

It may be desirable to incorporate an optional alarm button 40 (e.g., bell, buzzer, or other audible tone) into or on the illumination accessory 10. In the event the user is in need of assistance, the user simply manipulates the alarm button 40 to summon help. In the illustrated embodiment, optional alarm button 40 is positioned near the base of one of the vertical light supporting structure 14 to enable the user to reach the optional alarm button 40 in the event the user falls and is unable to stand up.

Attachment members 44 are provided to selectively attach the accessory 10 to the walker 5. In the illustrated embodiment, the attachment member 44 comprises two clamps on each vertical light supporting structure 14. Other attachment members 44 include, e.g., straps, screws, adhesives, hooks, ties, bolts, screws, nuts, welded components, fitted components, interlocking components, Velcro straps etc.

1. An illumination accessory for a walker comprising
at least one non-flammable light supporting structure;
at least one attachment member adapted to attach said at least one light supporting structure to at least one structural component of a walker; and
at least one shatter-resistant, light emitting component which will not cause burns on skin.

2. The accessory of claim 1 in which said at least one light emitting component is flush mounted on said at least one light supporting structure.

3. The accessory of claim 1 in which said light supporting structure is selected from a group consisting of a substantially horizontal component, a substantially vertical component, and a structure placed at an angle.

4. The accessory of claim 1 wherein said light supporting structure further includes at least one attachment member consisting of a group consisting of a Velcro strap, a tie, a fastening band, an elastic strap, a clamp, a plastic semi-circular clamp, a screw, a bolt, an adhesive, a welding component, a magnet, a fitting, an interlocking component, a snap, a metal clamp, and a vise.

5. The accessory of claim 4 wherein said attachment member is used to temporarily affix said at least one light supporting structure to said walker.

6. The accessory of claim 4 wherein said attachment member is used to permanently affix said at least one light supporting structure to said walker.

7. The accessory of claim 1 which further includes at least one rechargeable light emitting component.

8. The accessory of claim 1 which further includes at least one phosphorescent component.

9. The accessory of claim 1 which further includes at least one convex light supporting structure fitted to correspond to a tubular member of said walker.

10. The accessory of claim 1 which further includes an audible component which may be activated by a user.

11. The accessory of claim 1 which further includes at least one switch which controls the flow of power to said at least one light emitting component.

12. The accessory of claim 1 in which said at least one light emitting component is an LED light.

13. The accessory of claim 1 in which said support structure is singly molded.

14. The accessory of claim 1 which further includes a means for selectively attaching and detaching said accessory to said walker.

15. An illumination accessory as in claim 1, further comprising at least one horizontal light supporting structure joining first and second vertical light supporting structures.

16. An illumination accessory for a walker comprising
at least one non-flammable light supporting structure;
at least one attachment member adapted to attach said at least one light supporting structure to at least one structural component of said walker;
at least one shatter-resistant, light emitting component which will not cause burns on skin;
at least one power source; and
at least one switch which controls the flow of power to said at least one light emitting component.

17. The accessory of claim 16 which further includes at least one convex light supporting structure fitted to correspond to a tubular member of said walker.

18. The accessory of claim 16 which further includes an audible component which may be activated by a user.

19. The accessory of claim 16 in which said at least one light emitting component is selected from a group consisting of a LED light, a phosphorescent material, a standard bulb that is flush mounted, and an intermittently flashing light.

20. A selectively attachable illumination accessory for a walker comprising
at least one non-flammable light supporting structure;
at least one attachment member adapted to temporarily attach said at least one light supporting structure to at least one structural component of said walker;
at least one shatter-resistant, light emitting component which will not cause burns on skin;
at least one power source; and
at least one switch which controls the flow of power to said at least one light emitting component.
